(19) United States
(12) Patent Application Publication
(10) Pub. No.: US 2012/0231353 A1
(43) Pub. Date: Sep. 13, 2012

(54) PROCESS FOR PRODUCING OXYGEN-CONSUMING ELECTRODES

(75) Inventors: Andreas Bulan, Langenfeld (DE); Walter Klesper, Bergisch-Gladbach (DE)

(73) Assignee: Bayer MaterialScience AG, Leverkusen (DE)

(21) Appl. No.: 13/411,739

(22) Filed: Mar. 5, 2012

(30) Foreign Application Priority Data
Mar. 11, 2011 (DE) 10 2011 005 454.5

(51) Int. Cl. H01M 4/90; H01M 4/88; H01M 8/22; H01M 4/86; C25B 9/00; C25B 11/04

(52) U.S. Cl. 429/405; 204/242; 204/290.01; 429/523; 427/77; 502/1

(57) ABSTRACT

The present invention relates to a process for producing an oxygen-consuming electrode that includes the steps of (a) producing a powder mixture consisting of at least one polymer as binder and a catalytically active component, (b) applying the powder mixture to an electrically conductive sheet-like support element, and (c) compacting and consolidating the powder mixture on the support element using rollers, wherein the rollers used in the compaction step c) comprises a surface coating of tungsten carbide and wherein the roller surface has a roughness of not more than 0.5 μm.

### CROSS REFERENCE TO RELATED APPLICATIONS

Priority is claimed to German patent Application No. 10 2011 005 454.5 filed on Mar. 11, 2011 which is incorporated herein by reference in its entirety for all useful purposes.

### BACKGROUND

The invention relates to a process for producing oxygen-consuming electrodes, in particular for use in chloralkali electrolysis, by use of specific rollers for compaction of the catalyst composition on the support element. The invention further relates to the use of the oxygen-consuming electrodes produced by this process in chloralkali electrolysis or fuel cell technology.

The invention proceeds from production processes known per se for oxygen-consuming electrodes which are configured as sheet-like gas diffusion electrodes and usually comprise an electrically conductive support and a gas diffusion layer containing a catalytically active component.

Various proposals for operating oxygen-consuming electrodes in electrolysis cells of industrial size are known in principle from the prior art. The basic idea is to replace the hydrogen-evolving cathode of the electrolysis (for example in chloralkali electrolysis) by the oxygen-consuming electrode (cathode). An overview of possible cell designs and solutions may be found in the publication by Moussallem et al “Chlor-Alkali Electrolysis with Oxygen Depolarized Cathodes: History, Present Status and Future Prospects”, J. Appl. Electrochem. 38 (2008) 1177-1194.

The oxygen-consuming electrode—hereinafter also referred to as OCE for short—has to meet a series of requirements in order to be usable in industrial electrolysers. Thus, the catalyst and all other materials used have to be chemically stable to sodium hydroxide solution having a concentration of about 32% by weight and to pure oxygen at a temperature of typically 80-90° C. Likewise, a high degree of mechanical stability is required since the electrodes are installed and operated in electrolysers having a size of usually more than 2 m² in area (industrial size). Further properties are: a high electrical conductivity, a low layer thickness, a high internal surface area and a high electrochemical activity of the electrocatalyst. Suitable hydrophobic and hydrophilic pores and an appropriate pore structure for the conduction of gas and electrolyte are likewise necessary, as is impermeability so that gas space and liquid space remain separated from one another. The long-term stability and low production costs are further particular requirements which an industrially usable oxygen-consuming electrode has to meet.

A preferred process for producing oxygen-consuming electrodes is described in DE3710168A1. In this process, a mixture of catalyst and a polymeric component is milled to fine particles. The powder mixture is subsequently compacted to form a sheet-like structure and the sheet-like structure is then applied to an electrically conductive support element by pressing.

The compaction of the particles to form a sheet-like structure and also the pressing of the sheet-like structure onto the support element are, for example, carried out by means of a roller press or by means of a calendar.

DE 10148599A1 names a series of particular conditions for the compaction of catalyst and polymer to form a stable sheet-like structure:
the roller gap during the rolling process for the powder mixture can be kept constant with a closure force of the rollers in the range from 0.2 N/cm to 15 N/cm;
the surface roughness of the rollers can be from 0.05 to 1.5 μm;
the circumferential velocity of the rollers during the rolling process can be from 0.05 to 15 m/min;
the roller diameter can be up to 30 cm at a closure force of up to 15 kN/cm;
the roller gap set can be from 0.005 to 0.45 mm;
the rollers can be coolable.

According to the teaching of DE 10148599A1, oxygen-consuming electrodes having a width of 30-40 cm and a length of 2-3 m can be produced by this process.

EP 1728896 A2 discloses another process in which a milled mixture of catalyst and a polymeric component is applied directly to an electrically conductive support element and then pressed together with the support element.

The forces during pressing should in this case be kept as low as possible in the range from 0.01 to 7 kN/cm. EP 1728896 A2 indicates that the production process by means of rollers which is described is independent of the material, the surface roughness and the diameter of the rollers used for pressing.

A disadvantage of the abovementioned known processes which provide for production by means of rollers is that the compressed catalyst layer easily adheres to the surface of the rollers. As a result, the rolling process has to be interrupted relatively frequently. The rollers have to be freed of adhering noble metal-containing catalyst mixture, defective electrodes have to be sorted out and the valuable coating of the sorted-out electrodes has to be recycled in a complicated fashion.

Such deficiencies can be tolerated to some extent for production of a small number of electrodes on a small scale in laboratory plants. However, such processes with frequent interruptions and high reject rates are completely unsuitable for the manufacture of large-area electrodes on an industrial scale.

DE 10157521 A1 discloses that adhering catalyst composition on the pressing rollers can be avoided to a certain extent by treatment of the rollers with specific organic compounds. According to this document, treatment of the roller surface with the substances enables oxygen-consuming electrodes having a width of 40 cm and a length of 2 m to be produced.

However, electrodes having a width considerably greater than 40 cm are required for the production of OCEs on an industrial scale. Electrodes having a width of typically more than one metre, sometimes a width of up to 2 metres, are customary for conventional membrane electrolysers. The length of the coating should also not be limited by the production process if at all possible.

The process described in DE 10157521 A1 has been found to be excessively complicated for a continuous production process. The pressing operation has to be continually interrupted for treatment of the rollers with liquid; the rollers have to be washed with the organic liquids and dried. The surrounding air is polluted by evaporation of the organic components, as a result of which special extraction and air purification installations are again required.

It is an object of the present invention to discover a process for producing oxygen-consuming electrodes, in particular for use in chloralkali electrolysis, which can be operated continuously for relatively large areas and numbers of items and which does not have the above-described disadvantages of the known production processes and the electrodes produced thereby, in particular the complicated use of non-stick agents.

It is a specific object of embodiments of the present invention to provide a process for pressing catalyst compositions, which process can be operated without interruptions due to adhesion of material to the pressing rollers and by means of which electrodes having a width of >1.5 m can be produced in a continuous process.

These objects are achieved by compaction and pressing being carried out in a roller press in which the pressing roller is coated with tungsten carbide and has a surface roughness of not more than 0.5 μm.

### BRIEF DESCRIPTION OF PREFERRED EMBODIMENTS

An embodiment of the present invention provides a process for producing an oxygen-consuming electrode comprising:
a) producing a powder mixture consisting of at least one polymer as binder and a catalytically active component,
b) applying the powder mixture to an electrically conductive sheet-like support element, and
c) compacting and consolidating the powder mixture on the support element using rollers,
   wherein the rollers used in the compaction step c) comprises a surface coating of tungsten carbide and wherein the roller surface has a roughness of not more than 0.5 μm.

Another embodiment of the present invention is the above proves, wherein the at least one polymer comprises a fluorinated polymer.

Another embodiment of the present invention is the above proves, wherein the at least one polymer comprises polytetrafluoroethylene (PTFE).

Another embodiment of the present invention is the above proves, wherein the roller surface has roughness of from 0.1 to 0.35 μm

Another embodiment of the present invention is the above proves, wherein the compaction c) of the powder mixture is carried out with a compaction ratio of from 2.5:1 to 6:1.

Another embodiment of the present invention is the above proves, wherein the compaction c) of the powder mixture is carried out with a compaction ratio of from 3:1 to 4:1.

Another embodiment of the present invention is the above proves, wherein the compaction step c) comprises using at least one pair of rollers which are located above one another.

Another embodiment of the present invention is the above proves, wherein both rollers are driven by a motor.

Another embodiment of the present invention is the above proves, wherein the compaction step c) comprises using at least one pair of rollers comprising an upper roller and a lower roller, wherein the upper roller is located above the lower roller, and wherein the upper roller is mounted so as to be movable relative to the lower roller for setting the compaction ratio.

Another embodiment of the present invention is the above proves, wherein the linear force which acts on the powder material and the support element during the compaction step c) is from 0.2 to 2 kN/cm.

Another embodiment of the present invention is the above proves, wherein the catalystically active component comprises powder of silver, silver(I) oxide or silver(II) oxide or mixtures of silver powder and silver oxide powder.

Another embodiment of the present invention is the above proves, wherein the powder mixture comprises 70 to 95% by weight of silver(I) oxide, 0-15% by weight of silver metal powder and 3-15% by weight of a fluorinated polymer.

Another embodiment of the present invention is the above proves, wherein the support element comprises a flexible textile structure.

Another embodiment of the present invention is the above proves, wherein the support element comprises a flexible textile structure comprising metal threads and further comprises nickel and/or silver-coated nickel.

Another embodiment of the present invention is the above proves, wherein the gap between the rollers is set so that it is from 0.2 to 0.8 mm under force.

Another embodiment of the present invention is the above proves, wherein the circumferential velocity of the rollers during the compaction step c) is from 0.1 to 20 m/min.

Another embodiment of the present invention is the above proves, wherein the circumferential velocity of the rollers during the compaction step c) is from 1 to 15 m/min.

Yet another embodiment of the present invention is a metal/air battery or a fuel cell comprising an electrode produced by the above process.

Yet another embodiment of the present invention is an oxygen-consuming electrode obtained from the above process.

Yet another embodiment of the present invention is an electrolysis apparatus comprising an oxygen-consuming electrode made by the above process as an oxygen-consuming cathode.

### DETAILED DESCRIPTION OF PREFERRED EMBODIMENTS

As used herein, the singular terms “a” and “the” are synonymous and used interchangeably with “one or more” and “at least one,” unless the language and/or context clearly indicates otherwise. Accordingly, for example, reference to “a catalytically active component” herein or in the appended claims can refer to a catalytically active component or more than one catalytically active component. Additionally, all numerical values, unless otherwise specifically noted, are understood to be modified by the word “about.”

An embodiment of the invention provides a process for producing an oxygen-consuming electrode, which comprises the steps:
a) production of a powder mixture consisting of at least one polymer as binder, preferably polytetrafluoroethylene (PTFE), and a catalytically active component, preferably a component comprising silver oxide and/or silver as catalytically active material,
b) application of the powder mixture to an electrically conductive sheet-like support element,
c) compaction and consolidation of the powder mixture on the support element by means of rollers,

characterized in that the compacting rollers used in the compaction step c) have a surface coating of tungsten carbide and have a roughness of the roller surface of not more than 0.5 μm, particularly preferably from 0.1 to 0.35 μm.

The powder mixture comprises at least a catalyst and a binder. As catalyst, preference is given to using silver, silver(I) oxide or silver(II) oxide or mixtures thereof. The binder is a polymer, preferably a fluorinated polymer, particularly preferably polytetrafluoroethylene (PTFE). Particular preference is given to using powder mixtures containing from 70 to 95% by weight of silver(I) oxide, 0-15% by weight of silver metal powder and 3-15% by weight of fluorinated polymers, in particular PTFE.

The support element can, in particular, be used in the form of a mesh, nonwoven, foam, woven fabric, braid, knitted fabric, expanded metal or another permeable sheet-like structure. Preference is given to using a flexible textile structure, in particular one made of metal threads. Nickel and silver-coated nickel are particularly suitable as material for the support element.

The preparation and application of the powder mixture to the support element is, in a preferred embodiment, carried out in a manner analogous to that described in EP 1728896A2.

The rollers coated with tungsten carbide draw the support coated with powder in surprisingly well without adhesion of powder mixture to the rollers occurring, A uniform, stable coating of the powder composition on the support element is obtained.

Rollers coated with tungsten carbide display, in particular, a low tendency for powder mixtures of PTFE and a mixture of silver oxide and silver, as are preferably used for the production of oxygen-consuming electrodes, to adhere. However, adhesion is sufficient to ensure good drawing-in of the powder mixture into the roller gap and transport of the compacted powder mixture. In addition, the hardness of tungsten carbide is sufficiently high for the rollers not be damaged by any relatively coarse particles, e.g. of silver oxide, present. Coarse silver oxide particles are broken up into smaller pieces by the pressure of the roller.

Coating of the rollers, which are typically made of stainless steel, is preferably carried out in a flame spraying process, particularly preferably in a plasma spraying process. The coating is preferably hardened inductively. The hardness of the roller which is preferably used is preferably at least 70 Rockwell.

The rollers have a surface roughness in accordance with DIN EN ISO 4287 of Ra≦0.5 μm, preferably Ra≦0.35 μm, particularly preferably Rap=0.1-0.35 μm. A higher roughness leads to unevennesses on the electrode surface which can impair the performance of the electrode. A further reduction in the roughness to far below Ra=0.1 μm brings no further advantages in the quality of the electrodes, but in the case of roughness below Ra=0.1 μm the outlay for manufacture and grinding of the rollers increases disproportionately.

The compaction of the catalyst compositions on the support element is preferably carried out in a single pass through at least one pair of rollers. Here, a tungsten carbide-coated design is preferably selected for both rollers. In the case of electrodes in which the catalyst layer is present on only one side of the electrically conductive support element, it can be sufficient for only one roller which faces the catalyst layer to be coated with tungsten carbide.

In a preferred process, the rollers are both actively driven with the same speed of rotation. However, arrangements in which only one of the rollers is driven and the second roller runs alongside without its own drive are also possible.

However, the compaction c) of the powder material can in principle also be carried out using only one roller which acts on an intrinsically flat substrate, with either the substrate or the roller being moved.

The use of a continuous process is preferred for the production of relatively large numbers of electrodes.

Such a process will preferably involve continuous coating and pressing by means of a calendar. Particular preference is given to a process in which the support element is supplied continuously, e.g. from a roll, then drawn continuously into the coating unit and subsequently pressed together with the electrode powder mixture.

The electrodes can then be cut to size or else be rolled up for future cutting up. Such a continuous procedure for producing a sheet-like structure but without the preferred direct coating of the conductive support which is described here is outlined in principle in the document DE10130441B4.

For smaller numbers of items, an at least semicontinuous process in which a plurality of electrodes are coated and pressed will be sought.

The accuracy of the roundness of the rollers in the assembled state preferably has a deviation of not more than ±0.001 mm.

The linear force which acts on the powder material and the support element during the compaction step c) is preferably from 0.2 to 2 kN/cm.

The roller gap is preferably set so that under force it is from 0.2 to 0.8 mm.

The roller speed (=circumferential velocity of the rollers) during the compaction step c) is preferably 0.1-20 m/min, particularly preferably 1-15 m/min.

Roller widths of up to 2 m and above are possible. The rollers are preferably designed so that they can be connected to a heating/cooling circuit. This enables, for example, the temperature stress on the powder mixture to be limited. Compaction is preferably carried out at a temperature of the rollers of not more than 80° C., preferably not more than 55° C., particularly preferably not more than 30° C., at which, for example, a PTFE/silver/silver oxide mixture can be processed most readily.

The catalyst composition is compacted to a compaction ratio of from 2.5:1 to 6:1, preferably from 3:1 to 4:1. This means that at a ratio of 3:1 the mixture of catalytically active component and polymeric binder applied to the support element is compressed to one third of the original height of the bed.

The oxygen-consuming electrode produced by the novel process is preferably connected as cathode, in particular in an electrolysis cell for the electrolysis of alkali metal chlorides, preferably sodium chloride or potassium chloride, particularly preferably sodium chloride.

As an alternative, the oxygen-consuming electrode produced by the novel process can preferably be connected as cathode in a fuel cell.

Another embodiment of the present invention therefore further provides for the use of the oxygen-consuming electrode produced by the novel process for the reduction of oxygen in an alkaline medium, in particular in an alkaline fuel cell, the use in mains water treatment, for example for the preparation of sodium hypochlorite, or the use in chloralkali electrolysis, in particular for the electrolysis of LiCl, KCl or NaCl.

The novel oxygen-consuming electrode produced by the novel process is particularly preferably used in chloralkali electrolysis and here especially in the electrolysis of sodium chloride (NaCl).

Embodiments of the present invention is illustrated below by the examples with the aid of the figures, without implying a restriction of the invention.

### EXAMPLES

### Example 1

3.5 kg of a powder mixture consisting of 7% by weight of PTFE powder, 88% by weight of silver(I) oxide and 5% by weight of silver powder type 331 from Ferro were mixed at a rotational speed of 6000 rpm in a mixer from Eirich, model R02, equipped with a star impeller as mixing element in such a way that the temperature of the powder mixture did not exceed 55° C. This was achieved by the mixing operation being interrupted and the mixture being cooled in a coolroom. Mixing was carried out for a total of three times. After mixing, the powder mixture was sieved through a fine sieve having a mesh opening of 1.0 mm.

The sieved powder mixture was subsequently applied to a mesh of silver-plated nickel wire having a wire thickness of 0.25 mm and a mesh opening of 0.5 mm. The area was 25×30 cm. Application was carried out with the aid of a 2 mm thick template, with the powder being applied by means of a sieve having a mesh opening of 1 mm. Excess powder which projected above the thickness of the template was removed by means of a scraper.

After removal of the template, the support with the applied powder mixture was introduced into a roller press consisting of 2 smooth, chromium-plated rollers having a diameter of 13 cm. The feed rate was 140 cm/min, and the pressing force was 0.45 kN/cm. The electrode after pressing had a thickness of 0.5 mm.

The upper roller displayed adhesion of catalyst composition; at some places, this even occurred on the lower roller. The electrode had defects without sufficient coating at a few places, particularly on the upper (coating) side. The electrode was unusable for electrolysis.

### Example 2

A wire mesh was treated with the same powder mixture as in Example 1.

The support with the applied powder mixture was introduced into a roller press consisting of two steel rollers having a diameter of 13 cm. The rollers had been coated with tungsten carbide in a flame spraying process and ground to a surface roughness of Ra=0.25 μm (measured in accordance with DIN EN ISO 4287). The feed rate into the rollers was 140 cm/min, the pressing force was 0.45 kN/cm and the electrode was compressed to a thickness of 0.52 mm.

Neither the upper roller nor the lower roller displayed adhering catalyst composition. The electrode was defect-free and ready-to-use.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A process for producing an oxygen-consuming electrode comprising:
a) producing a powder mixture consisting of at least one polymer as binder and a catalytically active component,
b) applying the powder mixture to an electrically conductive sheet-like support element, and
c) compacting and consolidating the powder mixture on the support element using rollers,
wherein the rollers used in the compaction step c) comprises a surface coating of tungsten carbide and wherein the roller surface has a roughness of not more than 0.5 μm.

2. The process according to claim 1, wherein the at least one polymer comprises a fluorinated polymer.

3. The process according to claim 1, wherein the at least one polymer comprises polytetrafluoroethylene (PTFE).

4. The process according to claim 1, wherein the roller surface has roughness of from 0.1 to 0.35 μm.

5. The process according to claim 1, wherein the compaction c) of the powder mixture is carried out with a compaction ratio of from 2.5:1 to 6:1.

6. The process according to claim 1, wherein the compaction c) of the powder mixture is carried out with a compaction ratio of from 3:1 to 4:1.

7. The process according to claim 1, wherein the compaction step c) comprises using at least one pair of rollers which are located above one another.

8. The process according to claim 7, wherein both rollers are driven by a motor.

9. The process according to claim 1, wherein the compaction step c) comprises using at least one pair of rollers comprising an upper roller and a lower roller, wherein the upper roller is located above the lower roller, and wherein the upper roller is mounted so as to be movable relative to the lower roller for setting the compaction ratio.

10. The process according to claim 1, wherein the linear force which acts on the powder material and the support element during the compaction step c) is from 0.2 to 2 kN/cm.

11. The process according to claim 1, wherein the catalystically active component comprises powder of silver, silver(I) oxide or silver(II) oxide or mixtures of silver powder and silver oxide powder.

12. The process according to claim 1, wherein the powder mixture comprises 70 to 95% by weight of silver(I) oxide, 0-15% by weight of silver metal powder and 3-15% by weight of a fluorinated polymer.

13. The process according to claim 1, wherein the support element comprises a flexible textile structure.

14. The process according to claim 1, wherein the support element comprises a flexible textile structure comprising metal threads and further comprises nickel and/or silver-coated nickel.

15. The process according to claim 1, wherein the gap between the rollers is set so that it is from 0.2 to 0.8 mm under force.

16. The process according to claim 1, wherein the circumferential velocity of the rollers during the compaction step c) is from 0.1 to 20 m/min.

17. The process according to claim 1, wherein the circumferential velocity of the rollers during the compaction step c) is from 1 to 15 m/min.

18. A metal/air battery or a fuel cell comprising an electrode produced by the process according to claim 1.

19. An oxygen-consuming electrode obtained from the process according to claim 1.

20. An electrolysis apparatus comprising an oxygen-consuming electrode made by the process according to claim 1 as an oxygen-consuming cathode.
